(19) United States
(12) Patent Application Publication
(10) Pub. No.: US 2008/0235677 A1
(43) Pub. Date: Sep. 25, 2008

(54) METHOD AND SYSTEM FOR CATEGORIZED AUTO-COMPLETION

(76) Inventors: Chris Aniszczyk, Austin, TX (US); Nikhil Kumar Batra, Houston, TX (US); Yasmary Hernandez, Miami, FL (US); Nathan Shlomo Marz, San Diego, CA (US); Lee Parnell Thompson, Cedar City, UT (US)

Correspondence Address: IBM CORP (YA);C/O YEE & ASSOCIATES PC, P.O. BOX 802333, DALLAS, TX, 75380, US

(21) Appl. No.: 11/687,980

(22) Filed: Mar. 19, 2007

(51) Int. Cl. G06F 9/44

(52) U.S. Cl. 717/165

(57) ABSTRACT

A computer implemented method, data processing system, and computer program product for providing an auto-completion assist box comprising different views of selectable method and field information, thereby allowing a user to easily locate desired information. A list of methods for an object is provided to one or more view plug-ins in the auto-completion system, wherein each view plug-in manages the list of methods according to a function of the view plug-in to form a managed view. Responsive to receiving a managed view from each view plug-in, an auto-completion assist box is created which comprises the managed views. The auto-completion assist box is then presented to a user, wherein the user selects a managed view to locate a method for the object for code assistance.

### BACKGROUND OF THE INVENTION

1. Field of the Invention

The present invention relates generally to an improved data processing system, and in particular to a computer implemented method, data processing system, and computer program product for providing an auto-completion assist box comprising different views of selectable method and field information, thereby allowing a user to easily locate the desired information.

2. Description of the Related Art

Auto-completion is a code assistance feature which completes code statements by presenting a pop-up window comprising supported arguments for the function call being coded or the supported properties and methods on the desired object. For instance, when a user creates an object, the user may invoke different methods of the class. However, since a user may often forget a particular method name or a parameter type, auto-completion provides the user with possible alternatives which the user may select to complete the code statement.

When receiving a list of methods for a class from auto-completion, current auto-completion systems provide all of the possible methods for the class to the user in a list view, including those methods from super classes. While the auto-completion feature provides the user with all of the methods for the class, the list of methods are presented to the user in alphabetical order, and thus the only way to navigate the list of all of the possible methods is to do so alphabetically. Presenting all of the methods together in a single list can be problematic when the user is trying to locate a particular method. For example, this problem is especially noticeable when using a widget class, which may be the child in a hierarchy of five or more classes. To find the method specific to the child class, the user would have to scroll through the object methods, the component methods, etc.

### SUMMARY OF THE INVENTION

The illustrative embodiments provide a computer implemented method, data processing system, and computer program product for providing an auto-completion assist box comprising different views of selectable method and field information, thereby allowing a user to easily locate desired information. A list of methods for an object is provided to one or more view plug-ins in the auto-completion system, wherein each view plug-in manages the list of methods according to a function of the view plug-in to form a managed view. Responsive to receiving a managed view from each view plug-in, an auto-completion assist box is created which comprises the managed views. The auto-completion assist box is then presented to a user, wherein the user selects a managed view to locate a method for the object for code assistance.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 depicts a pictorial representation of a distributed data processing system in which the illustrative embodiments may be implemented;

FIG. 2 is a block diagram of a data processing system in which the illustrative embodiments may be implemented;

FIG. 3 is a block diagram of exemplary components with which the illustrative embodiments may be implemented;

FIG. 4 is an exemplary auto-completion assist box comprising multiple views of method or field information in accordance with the illustrative embodiments; and

FIG. 5 is a flowchart of a process for implementing auto-completion with multiple views of method or field information in accordance with the illustrative embodiments.

### DETAILED DESCRIPTION OF THE PREFERRED EMBODIMENT

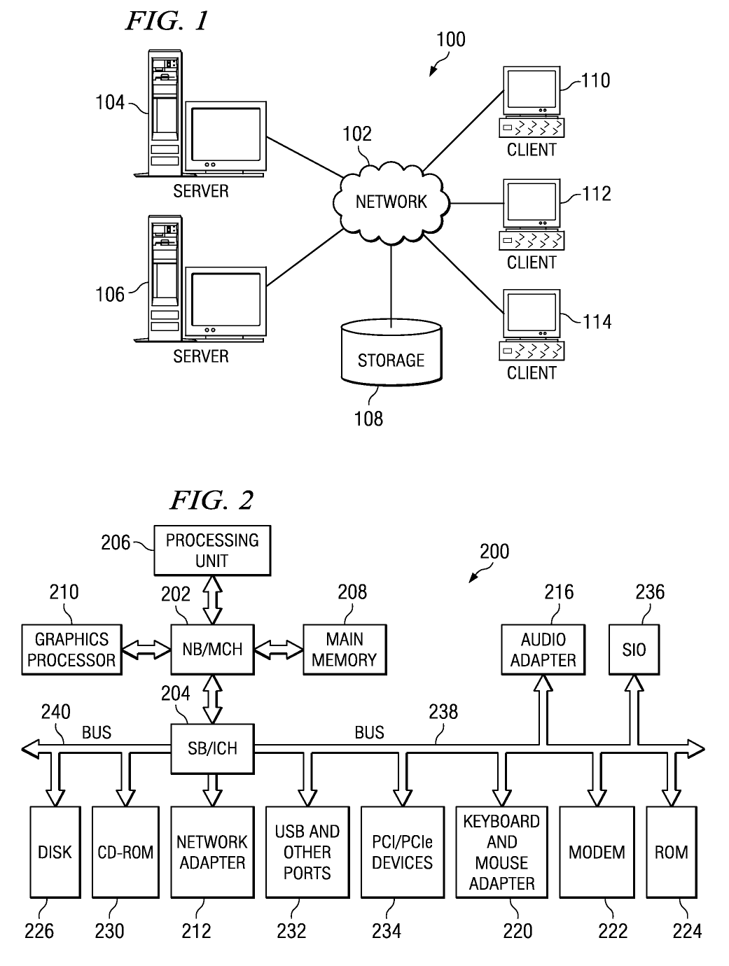

With reference now to the figures and in particular with reference to FIGS. 1-2, exemplary diagrams of data processing environments are provided in which illustrative embodiments may be implemented. It should be appreciated that FIGS. 1-2 are only exemplary and are not intended to assert or imply any limitation with regard to the environments in which different embodiments may be implemented. Many modifications to the depicted environments may be made.

FIG. 1 depicts a pictorial representation of a network of data processing systems in which illustrative embodiments may be implemented. Network data processing system 100 is a network of computers in which the illustrative embodiments may be implemented. Network data processing system 100 contains network 102, which is the medium used to provide communications links between various devices and computers connected together within network data processing system 100. Network 102 may include connections, such as wire, wireless communication links, or fiber optic cables.

In the depicted example, server 104 and server 106 connect to network 102 along with storage unit 108. In addition, clients 110, 112, and 114 connect to network 102. Clients 110, 112, and 114 may be, for example, personal computers or network computers. In the depicted example, server 104 provides data, such as boot files, operating system images, and applications to clients 110, 112, and 114. Clients 110, 112, and 114 are clients to server 104 in this example. Network data processing system 100 may include additional servers, clients, and other devices not shown.

In the depicted example, network data processing system 100 is the Internet with network 102 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers, consisting of thousands of commercial, governmental, educational and other computer systems that route data and messages. Of course, network data processing system 100 also may be implemented as a number of different types of networks, such as for example, an intranet, a local area network (LAN), or a wide area network (WAN). FIG. 1 is intended as an example, and not as an architectural limitation for the different illustrative embodiments.

With reference now to FIG. 2, a block diagram of a data processing system is shown in which illustrative embodiments may be implemented. Data processing system 200 is an example of a computer, such as server 104 or client 110 in FIG. 1, in which computer usable program code or instructions implementing the processes may be located for the illustrative embodiments.

In the depicted example, data processing system 200 employs a hub architecture including a north bridge and memory controller hub (NB/MCH) 202 and a south bridge and input/output (I/O) controller hub (SB/ICH) 204. Processing unit 206, main memory 208, and graphics processor 210 are coupled to north bridge and memory controller hub 202. Processing unit 206 may contain one or more processors and even may be implemented using one or more heterogeneous processor systems. Graphics processor 210 may be coupled to the NB/MCH through an accelerated graphics port (AGP), for example.

In the depicted example, local area network (LAN) adapter 212 is coupled to south bridge and I/O controller hub 204 and audio adapter 216, keyboard and mouse adapter 220, modem 222, read only memory (ROM) 224, universal serial bus (USB) and other ports 232, and PCI/PCIe devices 234 are coupled to south bridge and I/O controller hub 204 through bus 238, and hard disk drive (HDD) 226 and CD-ROM 230 are coupled to south bridge and I/O controller hub 204 through bus 240. PCI/PCIe devices may include, for example, Ethernet adapters, add-in cards, and PC cards for notebook computers. PCI uses a card bus controller, while PCIe does not. ROM 224 may be, for example, a flash binary input/output system (BIOS). Hard disk drive 226 and CD-ROM 230 may use, for example, an integrated drive electronics (IDE) or serial advanced technology attachment (SATA) interface. A super I/O (SIO) device 236 may be coupled to south bridge and I/O controller hub 204.

An operating system runs on processing unit 206 and coordinates and provides control of various components within data processing system 200 in FIG. 2. The operating system may be a commercially available operating system such as Microsoft® Windows® XP (Microsoft and Windows are trademarks of Microsoft Corporation in the United States, other countries, or both). An object oriented programming system, such as the Java programming system, may run in conjunction with the operating system and provides calls to the operating system from Java™ programs or applications executing on data processing system 200. Java™ and all Java™-based trademarks are trademarks of Sun Microsystems, Inc. in the United States, other countries, or both.

Instructions for the operating system, the object-oriented programming system, and applications or programs are located on storage devices, such as hard disk drive 226, and may be loaded into main memory 208 for execution by processing unit 206. The processes of the illustrative embodiments may be performed by processing unit 206 using computer implemented instructions, which may be located in a memory such as, for example, main memory 208, read only memory 224, or in one or more peripheral devices.

The hardware in FIGS. 1-2 may vary depending on the implementation. Other internal hardware or peripheral devices, such as flash memory, equivalent non-volatile memory, or optical disk drives and the like, may be used in addition to or in place of the hardware depicted in FIGS. 1-2. Also, the processes of the illustrative embodiments may be applied to a multiprocessor data processing system.

In some illustrative examples, data processing system 200 may be a personal digital assistant (PDA), which is generally configured with flash memory to provide non-volatile memory for storing operating system files and/or user-generated data. A bus system may be comprised of one or more buses, such as a system bus, an I/O bus and a PCI bus. Of course the bus system may be implemented using any type of communications fabric or architecture that provides for a transfer of data between different components or devices attached to the fabric or architecture. A communications unit may include one or more devices used to transmit and receive data, such as a modem or a network adapter. A memory may be, for example, main memory 208 or a cache such as found in north bridge and memory controller hub 202. A processing unit may include one or more processors or CPUs. The depicted examples in FIGS. 1-2 and above-described examples are not meant to imply architectural limitations. For example, data processing system 200 also may be a tablet computer, laptop computer, or telephone device in addition to taking the form of a PDA.

The illustrative embodiments provide an improved auto-completion system which provides alternate “views” of a list of methods for auto-completion. The auto-completion system in the illustrative embodiments takes the list comprising all of the methods which is typically presented in an auto-completion assist box and segregates the methods in the list by the specific class in which the methods were defined. In this manner, the illustrative embodiments provides a system for implementing auto-completion with additional views comprising the filtered lists of method information for an object, thereby allowing a user to easily locate the desired information.

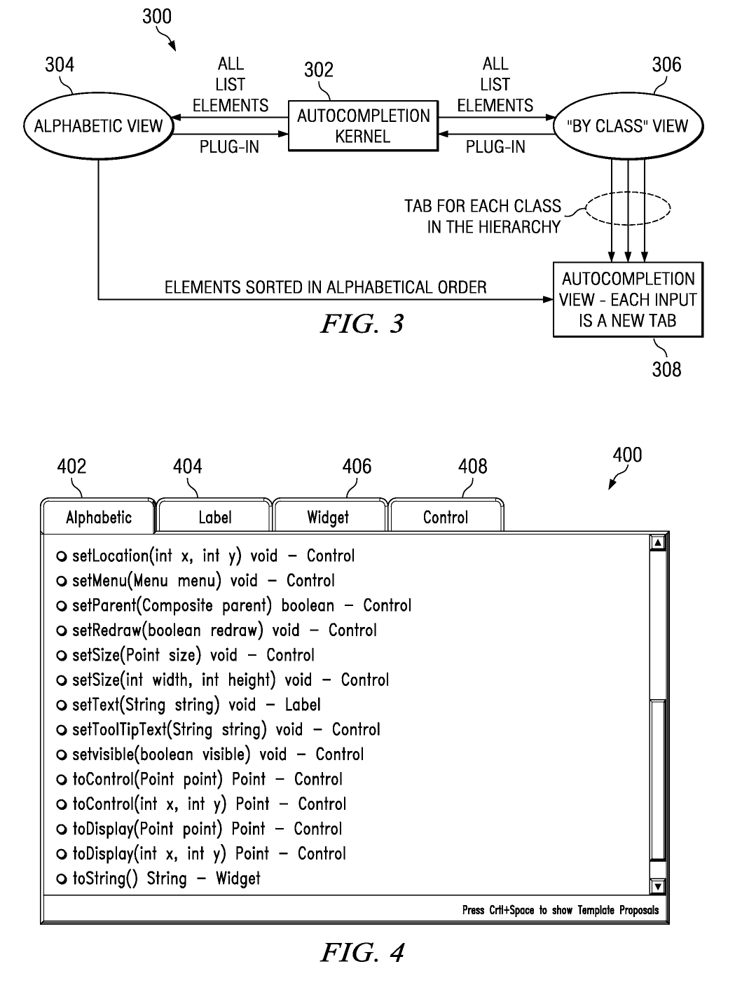

FIG. 3 is a block diagram of exemplary components with which the illustrative embodiments may be implemented. The exemplary components may be implemented in a data processing system, such as data processing system 200 in FIG. 2. System 300 comprises auto-completion kernel 302, “alphabetic” view plug-in 304, “by class” view plug-in 306, and auto-completion view 308.

Auto-completion kernel 302 is a plug-in infrastructure, such as the Eclipse™ plug-in architecture. Eclipse™ is an extensible platform comprising plug-ins which contribute functionality to the platform. A plug-in is a computer program that interacts with a main application to provide a certain function on-demand. Each plug-in comprises a service which is deployed or activated as needed. In this illustrative example, auto-completion kernel 302 allows auto-completion views such as “alphabetic” view plug-in 304 and “by class” view plug-in 306 to be plugged into the kernel.

Auto-completion kernel 302 provides all of the possible methods to each view plug-in, and each plug-in organizes the list of methods according to the plug-in function. When “alphabetic” view plug-in 304 receives a list of all methods from auto-completion kernel 302, “alphabetic” view plug-in 304 organizes the methods and creates a view which lists all method information associated with a particular object in alphabetical order. When “by class” view plug-in 306 receives a list of all methods from auto-completion kernel 302, “by class” view plug-in 306 organizes the methods and creates one or more views which group methods associated with a particular object according to the classes in which the methods were defined. Although the only plug-ins shown in this example are “alphabetic” view plug-in 304 and “by class” view plug-in 306, it should be noted that any other view plug-ins may be similarly used to organize and filter the list of methods in a desired manner.

Auto-completion view 308 is the view of possible method information which is presented to the user. While the list of all possible methods may be included in auto-completion view 308, the view from “alphabetic” view plug-in 304 and the view(s) from “by class” view plug-in 306 are also provided to auto-completion view 308, thereby providing alternate views of the possible method information for completing code statements. In one embodiment, each view provided to auto-completion view 308 may define any number of selectable tabs which the user may select to filter and sort the methods of the list in a custom way. For example, “alphabetic” view plug-in 304 may provide one tab which comprises a list of all methods associated with a particular object in alphabetical order. In contrast, “by class” view plug-in 306 may provide a plurality of tabs, one for each identified class in the hierarchy.

FIG. 4 is an exemplary auto-completion assist box comprising multiple views of method information in accordance with the illustrative embodiments. Auto-completion assist box 400 may be provided to a user using auto-completion view 308 in FIG. 3.

In this illustrative example, auto-completion assist box 400 is shown to comprise various view tabs, including alphabetic tab 402, label tab 404, widget tab 406, and control tab 408. More or fewer tabs may be provided, depending upon the plug-ins available to auto-completion kernel 302 in FIG. 3. One view tab, such as alphabetic tab 402, may be the default view tab which is displayed when auto-completion assist box 400 is initiated. Alphabetic tab 402 displays a list of all methods from the auto-completion kernel in alphabetical order, and may be created using “alphabetic” view plug-in 304 in FIG. 3. Label tab 404 comprises methods implemented in a “label” class. Widget tab 406 comprises methods implemented in a “widget” class. Control tab 408 comprises methods implemented in a “control” class. Label tab 404, widget tab 406, and control tab 408 may be created using “by class” view plug-in 306 in FIG. 3. In this example, the “control” class is a superclass, and the “label” class and “widget” class are children of the “control” superclass.

When a user selects another view tab, such as label tab 404, only those methods implemented in the label class are displayed to the user. Thus, by supplementing the alphabetic view in auto-completion assist box 400 with additional view tabs, such as label tab 404, a user does not need to sift through the entire alphabetic tab 402 list to locate a label class, which can be very tedious since most of the methods in alphabetic tab 402 are part of a “control” superclass. Consequently, the user may more easily locate a label class through label tab 404.

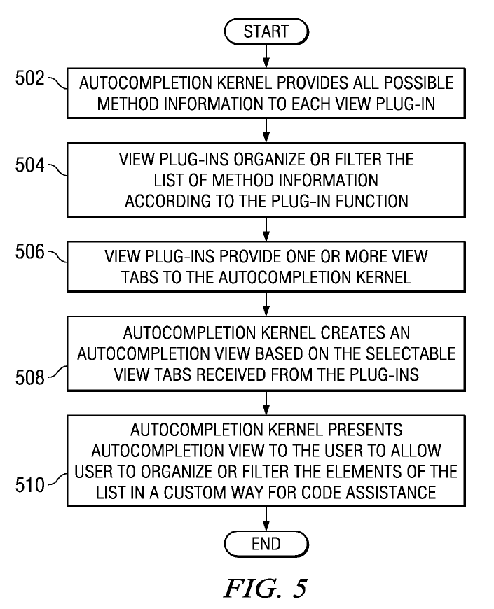

FIG. 5 is a flowchart of a process for implementing auto-completion with multiple views of method information in accordance with the illustrative embodiments. The process described in FIG. 5 may be implemented using the exemplary components in system 300 in FIG. 3. The process begins with the auto-completion kernel providing all possible methods for an object to each view plug-in (step 502). Each plug-in organizes the list of methods according to the plug-in function (step 504). For example, an “alphabetic” view plug-in organizes the methods and creates a view which lists all methods associated with a particular object in alphabetical order, and a “by class” view plug-in organizes the methods and creates one or more views which lists all methods associated with a particular object in groups according to the classes in which the methods were defined. Each plug-in then provides one or more view tabs to the auto-completion kernel (step 506). Auto-completion kernel then creates an auto-completion view based on the selectable view tabs received from the plug-ins (step 508). The auto-completion view, comprising an auto-completion assist box, is then presented to the user, which the user may select to filter and sort the methods of the list in a custom way for code assistance (step 510).

The invention can take the form of an entirely hardware embodiment, an entirely software embodiment or an embodiment containing both hardware and software elements. In a preferred embodiment, the invention is implemented in software, which includes but is not limited to firmware, resident software, microcode, etc.

Furthermore, the invention can take the form of a computer program product accessible from a computer-usable or computer-readable medium providing program code for use by or in connection with a computer or any instruction execution system. For the purposes of this description, a computer-usable or computer readable medium can be any tangible apparatus that can contain, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A computer implemented method for code assistance in an auto-completion system, the computer implemented method comprising:
providing a list of methods for an object to one or more view plug-ins in the auto-completion system, wherein each view plug-in manages the list of methods according to a function of the view plug-in to form a managed view;
responsive to receiving a managed view from each view plug-in, creating an auto-completion assist box comprising the managed views; and
presenting the auto-completion assist box to a user, wherein the user selects a managed view to locate a method for the object for code assistance.

2. The computer implemented method of claim 1, wherein each view plug-in manages the list of methods by one of organizing or filtering the methods according to the function of the view plug-in.

3. The computer implemented method of claim 2, wherein the plug-in is an alphabetic view plug-in, and wherein the alphabetic view plug-in organizes the methods in the list in alphabetical order.

4. The computer implemented method of claim 2, wherein the plug-in is a by class view plug-in, and wherein the by class view plug-in filters the list of methods into one or more views according to a class defined for each method.

5. The computer implemented method of claim 1, wherein the providing, creating, and presenting steps are performed by an auto-completion kernel.

6. The computer implemented method of claim 1, wherein the managed view comprises selectable view tabs.

7. A computer program product for code assistance in an auto-completion system, the computer program product comprising:
a computer usable medium having computer usable program code tangibly embodied thereon, the computer usable program code comprising:
computer usable program code for providing a list of methods for an object to one or more view plug-ins in the auto-completion system, wherein each view plug-in manages the list of methods according to a function of the view plug-in to form a managed view;
computer usable program code for creating, in response to receiving a managed view from each view plug-in, an auto-completion assist box comprising the managed views; and
computer usable program code for presenting the auto-completion assist box to a user, wherein the user selects a managed view to locate a method for the object for code assistance.
